(19) United States
(12) Patent Application Publication
(10) Pub. No.: US 2026/0019888 A1
(43) Pub. Date: Jan. 15, 2026

(54) SYSTEM AND METHOD FOR EPS FALLBACK

(71) Applicant: JIO PLATFORMS LIMITED, Ahmedabad (IN)

(72) Inventors: Brijesh SHAH, Navi Mumbai (IN); Yashesh BUCH, Navi Mumbai (IN); Sourabh BAJPAI, Dombivli East (IN); Mayank TARAN, Dombivli East (IN); Nitesh CHOURASIA, Palava City (IN); Kapil B GUPTA, Navi Mumbai (IN); Potti VASUDHA, Bangalore (IN); Srinivasa Rao VUNDAVILLI, Bangalore (IN); Jitendra PUNDIR, Palava City (IN); Aayush BHATNAGAR, Navi Mumbai (IN); Pradeep Kumar BHATNAGAR, Navi Mumbai (IN)

(73) Assignee: JIO PLATFORMS LIMITED, Ahmedabad (IN)

(21) Appl. No.: 18/992,147

(22) PCT Filed: May 2, 2024
(86) PCT No.: PCT/IN2024/050472

§ 371 Date: Jan. 7, 2025

(30) Foreign Application Priority Data
May 31, 2023 (IN) 202321037693

(51) Int. Cl. H04W 36/00; H04W 36/14

(52) U.S. Cl. CPC H04W 36/00222; H04W 36/0058; H04W 36/142

(57) ABSTRACT

The present disclosure automatically allows a user to make voice call on a Long-Term Evolution (LTE) network when a User Equipment (UE) (104, 310, 410, 510) is not capable to make voice call on a 5G Standalone (SA) network via redirection or via Handover. The present disclosure allows the user to release the 5G SA network and redirect to measured Evolved Universal Terrestrial Radio Access (E-UTRA) Absolute Radio Frequency Channel Number (EARFCN) of LTE band to proceed an Evolved Packet System Fallback (EPSFB) call successfully, if there is unprecedented failure during the handover procedure. The present disclosure allows the user to redirect to LTE Radio Access Technology (RAT) on default frequency band configured in gNodeB (gNB) ((320, 420, 520) during an emergency voice call or when B1 measurement delayed or not received, or while the UE (104, 310, 410, 510) is active with other procedure or stuck in race conditions.

### RESERVATION OF RIGHTS

A portion of the disclosure of this patent document contains material which is subject to intellectual property rights such as, but are not limited to, copyright, design, trademark, integrated circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of 5G standalone (SA) cellular technology, and specifically to a system and a method for Evolved Packet System Fallback (EPSFB).

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In general, voice over New Radio (NR) with Evolved Packet System Fallback (EPSFB) may be defined as a mobility procedure where a network triggers the procedure for a User Equipment (UE) to change Radio Access from 5G to 4G. EPSFB may enable mobile phones to use a 5G Core (5GC) with NR, but a Radio Access Network (RAN) may trigger moving the phone, i.e., Long-Term Evolution (LTE) connected to an Evolved Packet Core (EPC) during call establishment. EPSFB call although initiates on NR but eventually falls back to an LTE layer and succeeds over an EPC core network that is also connected to an Internet Protocol (IP) Multimedia Subsystem (IMS), effectively making it a Voice over Long-Term Evolution (VOLTE) call after the fallback.

Conventionally, a gNodeB (gNB) may configure the UE for B1 measurements and set a wait timer to receive a B1 measurement report, after getting a Packet Data Unit (PDU) session modification request from an Access and Mobility Management Function (AMF) for Quality of Service (QOS) flow of IMS voice. Due to some uncertainty, if the UE fails to send the B1 measurement before the wait timer expiry, EPSFB procedure via Inter Radio Access Technology (IRAT) handover fails and the UE is not able to make voice call. This issue is also observed when the EPSFB procedure via release with redirection to reported frequency is enabled. The gNB waits for the B1 measurement report from UE to take decision of release with redirection.

After getting the B1 measurement report from the UE, the gNB may initiate IRAT handover, but when the UE sends the B1 measurement report for LTE cell, which is not available in the NR to LTE neighbour list, EPSFB procedure fails, and the UE is not able to make voice call on system. When the gNB initiates IRAT handover procedure after receiving the B1 measurement report from the UE for valid LTE neighbour already available in NR to LTE neighbour list and handover fails in either preparation phase or in execution phase, the EPSFB procedure fails, and the UE is not able to make voice call on system and user faces the bad experience.

Further, EPS fallback may not be triggered by an Outdoor Small Cell (ODSC) when it receives an A3 event Measurement Report (MR) for Intra-FA handover to the neighbour cell while it is waiting for B1 MR to start EPSFB. EPSFB may not be triggered, when the UE already sent the A3 event measurement, the gNB is preparing for Intra-FA handover, and the PDU session modification request is received from the AMF for QOS flow of IMS voice.

There is, therefore, a need in the art to improve state of automatically allowing the user to make voice call on LTE network when the UE is not capable to make voice call on the 5G SA network via redirection or via handover.

### DEFINITION

As used in the present disclosure, the following terms are generally intended to have the meaning as set forth below, except to the extent that the context in which they are used to indicate otherwise.

The term B1 MR as used herein, refers to B1 measurement report. B1 is a measurement of the signal quality within a long-term evolution (LTE) system. B1 is measured at the eNodeB (eNB) and indicates the signal quality that a user equipment (UE) would receive from a femtocell if it were connected to that femtocell.

The term IRAT HO as used herein, refers to inter radio access technology handover. IRAT is mainly used for handover between different RAT. The UE while in one RAT performs neighbour cell measurements and sends measurement report to the network. Based on this measurement report provided by mobile terminal, network can initiate handover from one RAT to the other RAT.

The term EPSFB as used herein, refers to evolved packet system fallback. The EPSFB call is coordinated between a 5G system and evolved packet system (EPS), and transition of the call happens from 5G NR to the legacy LTE network after the negotiation of both UE and network capabilities,

The term E-UTRA as used herein, refers to evolved UMTS terrestrial radio access. The E-UTRA is the air interface of 3rd generation partnership project (3GPP) long term evolution (LTE) upgrade path for mobile networks.

The term EARFCN as used herein, refers to evolved universal terrestrial radio access (E-UTRA) absolute radio frequency channel number (EARFCN). In LTE, the carrier frequency in the uplink and downlink is designated by EARFCN. The EARFCN uniquely identify the LTE band and carrier frequency.

### OBJECTS OF THE PRESENT DISCLOSURE

It is an object of the present disclosure to automatically allow a user to make voice call on a Long-Term Evolution (LTE) network when a User Equipment (UE) is not capable to make voice call on a 5G Standalone (SA) network via redirection or via handover.

It is an object of the present disclosure to allow the user to release the 5G SA network and redirect to measured Evolved Universal Terrestrial Radio Access (E-UTRA) Absolute Radio Frequency Channel Number (EARFCN) of LTE band to proceed an Evolved Packet System Fallback (EPSFB) call successfully, if there is unprecedented failure during the handover procedure.

It is an object of the present disclosure to allow the user to redirect to LTE Radio Access Technology (RAT) on default frequency band configured in gNodeB (gNB) during the emergency voice call or when B1 measurement delayed or not received, or while the UE is active with other procedure or stuck in race conditions.

It is an object of the present disclosure to improvise the network capabilities.

It is an object of the present disclosure to enhance the user experience.

It is an object of the present disclosure to provide seamless network services to users.

It is an object of the present discourse to cater all sorts of voice calls.

### SUMMARY

In an exemplary embodiment, the present invention discloses a method for an evolved packet system fallback (EPSFB). The method comprising receiving, by a gNodeB, at least one packet data unit (PDU) session modification request related to a voice call for a user equipment (UE) connected to a first network. The method comprising determining if the gNodeB is active with the UE on at least one activity after receiving the PDU session modification request. When it is determined that the gNodeB is active with the UE on the at least one activity: aborting, by the gNodeB, the at least one activity; performing, by the gNodeB, a release of the UE from the connection with the first network and redirect the UE on a predefined configured frequency band of a second network. When it is determined that the gNodeB is not active with the at least one activity: configuring the UE with a first event measurement, starting a timer having a start time and an end time and performing, by the gNodeB, a release of the UE from the connection with the first network and redirect the UE on the predefined configured frequency band of the second network. The method comprising performing, by the gNodeB, a release of the UE from the connection with the first network and redirect the UE on the predefined configured frequency band of the second network when at least one of the following conditions are met a first measurement report (MR) associated with the one first event measurement is not received between the start time and the end time of the timer, and at least one second MR related to at least one second event measurement is received from the UE after the UE is configured with the first event measurement.

In some embodiments, the at least one UE is registered with at least one radio resource control (RRC) active mode with a downlink (DL) data session and an uplink (UL) data session.

In some embodiments, the at least one activity includes at least one inter-radio access technology (RAT) handover procedure.

In some embodiments, the first MR related to the first event measurement received from the UE is a B1 measurement report.

In some embodiments, the at least one second event measurement includes a measurement related to a A3 event and a A5 event.

In some embodiments, the PDU session modification request is received from an access & mobility management function (AMF) associated with the first network.

In some embodiments, the predefined configured frequency band of the second network is associated with an evolved universal terrestrial radio access (E-UTRA) absolute radio frequency channel number (EARFCN).

In some embodiments, the first network is a 5G network and the second network is a 4G long-term evolution (LTE) network.

In some embodiments, the EPSFB is triggered through a handover procedure or a redirection procedure depending upon a plurality of radio frequency (RF) conditions of the UE.

In some embodiments, the plurality of radio frequency (RF) conditions of the UE depends on a geographical area where the UE is located.

In some embodiments, the EPSFB is triggered through a handover procedure or a redirection procedure depending upon the at least one race condition generated in the first network.

In some embodiments, the gNodeB performs an emergency release of the UE from the connection with the first network and performs an emergency redirection of the UE on the predefined configured frequency band of the second network.

In some embodiments, the gNodeB performs the emergency redirection of the UE on the predefined configured frequency band of the second network instantly.

In some embodiments, the predefined configured frequency band is determined based on at least one of UE capability information message received from the UE, a message from the AMF that comprises an indication regarding a possibility of redirection for the EPSFB, N26 interface availability configuration and the plurality of RF conditions of the UE.

In an exemplary embodiment, the present invention discloses a system for an evolved packet system fallback (EPSFB). The system is configured to receive, by a gNodeB, at least one packet data unit (PDU) session modification request related to a voice call for a user equipment (UE) connected to a first network. The system is configured to determine if the gNodeB is active with the UE on at least one activity after receiving the PDU session modification request. When it is determined that the gNodeB is active with the UE on at least one activity: abort, by the gNodeB, the at least one activity; perform, by the gNodeB, a release of the UE from the connection with the first network and redirect the UE on a predefined configured frequency band of a second network. When it is determined that the gNodeB is not active with the at least one activity: configure the UE with a first event measurement; start a timer having a start time and an end time, perform, by the gNodeB, a release of the UE from the connection with the first network and redirect the UE on the predefined configured frequency band of the second network. The system is configured to perform, by the gNodeB, a release of the UE from the connection with the first network and redirect the UE on the predefined configured frequency band of the second network when at least one of the following conditions are met a first measurement report (MR) associated with the one first event measurement is not received between the start time and the end time of the timer, and at least one second MR related to at least one second event measurement is received from the UE after the UE is configured with the first event measurement.

In some embodiments, the at least one UE is registered with at least one radio resource control (RRC) active mode with a downlink (DL) data session and an uplink (UL) data session.

In some embodiments, the at least one activity includes at least one inter-radio access technology (RAT) handover procedure.

In some embodiments, the first MR related to the first event measurement received from the UE is a B1 measurement report.

In some embodiments, the at least one second event measurement includes a measurement related to a A3 event and a A5 event.

In some embodiments, the PDU session modification request is received from an access & mobility management function (AMF) associated with the first network.

In some embodiments, the predefined configured frequency band of the second network is associated with an evolved universal terrestrial radio access (E-UTRA) absolute radio frequency channel number (EARFCN).

In some embodiments, the first network is a 5G network and the second network is a 4G long-term evolution (LTE) network.

In some embodiments, the EPSFB is triggered through a handover procedure or a redirection procedure depending upon a plurality of radio frequency (RF) conditions of the UE.

In some embodiments, the plurality of radio frequency (RF) conditions of the UE depends on a geographical area where the UE is located.

In some embodiments, the EPSFB is triggered through a handover procedure or a redirection procedure depending upon the at least one race condition generated in the first network.

In some embodiments, the gNodeB performs an emergency release of the UE from the connection with the first network and performs an emergency redirection of the UE on the predefined configured frequency band of the second network.

In some embodiments, the gNodeB performs the emergency redirection of the UE on the predefined configured frequency band of the second network instantly.

In some embodiments, the predefined configured frequency band is determined based on at least one of UE capability information message received from the UE, a message from the AMF that comprises an indication regarding a possibility of redirection for the EPSFB, N26 interface availability configuration and the plurality of RF conditions of the UE.

In an exemplary embodiment, the present invention discloses a network comprising at least one network element for performing an evolved packet system fallback (EPSFB). The at least one network element is configured to receive, by a gNodeB, at least one packet data unit (PDU) session modification request related to a voice call for a user equipment (UE) connected to the network. The at least one network element is configured to determine if the gNodeB is active with the UE on at least one activity after receiving the PDU session modification request. The at least one network element is configured to responsive to determining that the gNodeB is active with the at least one activity: abort, by the gNodeB, the at least one activity, perform, by the gNodeB, a release of the UE from the connection with the network and redirect the UE on a predefined configured frequency band of another network. The at least one network element is configured to responsive to determining that the gNodeB is not active with the at least one activity: configure the UE with a first event measurement and start a timer having a start time and an end time. The at least one network element is configured to perform, by the gNodeB, a release of the UE from the connection with the network and redirect the UE on the predefined configured frequency band of the another network when at least one of the following conditions are met a first measurement report (MR) associated with the first event measurement is not received between the start time and the end time of the timer and at least one second MR related to at least one second event measurement from the UE after the UE is configured with the first event measurement.

In an exemplary embodiment, the present invention discloses a user equipment (UE) attached to a network. The network comprising at least one network element for performing an evolved packet system fallback (EPSFB). The at least one network element is configured to receive, by a gNodeB, at least one packet data unit (PDU) session modification request related to a voice call for the UE. The at least one network element is configured to determine if the gNodeB is active with the UE on at least one activity after receiving the PDU session modification request. The at least one network element is configured to responsive to determining that the gNodeB is active with the at least one activity: abort, by the gNodeB, the at least one activity, perform, by the gNodeB, a release of the UE from the connection with the network and redirect the UE on a predefined configured frequency band of another network. The at least one network element is configured to responsive to determining that the gNodeB is not active with the at least one activity: configure the UE with a first event measurement and start a timer having a start time and an end time. The at least one network element is configured to perform, by the gNodeB, a release of the UE from the connection with the network and redirect the UE on the predefined configured frequency band of the another network when at least one of the following conditions are met a first measurement report (MR) associated with the first event measurement is not received between the start time and the end time of the timer and at least one second MR related to at least one second event measurement from the UE after the UE is configured with the first event measurement.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an exemplary network architecture (100) in which or with which embodiments of the present disclosure may be implemented.

FIG. 2 illustrates an exemplary block diagram (200) of an Evolved Packet System Fallback (EPSFB) release system, in accordance with an embodiment of the present disclosure.

FIG. 3 illustrates an exemplary flow mechanism (300) of 5G to 4G Inter-Radio Access Technology (IRAT) handover, in accordance with an embodiment of the present disclosure.

FIG. 4 illustrates an exemplary flow mechanism (400) for performing 5G to 4G release with redirection, in accordance with an embodiment of the present disclosure.

FIG. 5 illustrates an exemplary flow mechanism (500) of EPSFB by emergency redirection, in accordance with an embodiment of the present disclosure.

FIG. 6 illustrates an exemplary flow diagram (600) for performing emergency release with redirection on predefined Long-Term Evolution (LTE) band, in accordance with an embodiment of the present disclosure.

FIG. 7 illustrates an exemplary computer system (700) in which or with which embodiments of the present disclosure may be implemented.

### LIST OF REFERENCE NUMERALS

100—Network architecture
102—A plurality of users
104, 310, 410, 510—User equipment (UE)
106—Network
108—Evolved packet system fallback (EPSFB) release system
200—Block Diagram
202—A plurality of processor(s)
204—Memory
206—A plurality of interface(s)
208—Processing engine
210—Configuration engine
212—Redirection engine
214—Database
300—Flow diagram
320, 420, 520—gNodeB
330, 430, 530—Access and mobility management function (AMF)
340, 440—Mobile management entity (MME)
350, 450—eNodeB
400—Flow diagram
500—Flow diagram
600—Flow diagram
700—A computer system
710—External storage device
720—Bus
730—Main memory
740—Read only memory
750—Mass storage device
760—Communication port(s)
770—Processor

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Generally, Voice over New Radio (NR) with Evolved Packet System Fallback (EPSFB) may be defined as a mobility procedure where a network triggers the procedure for a User Equipment (UE) to change Radio Access from 5G to 4G. EPSFB may enable phones to use a 5G Core (5GC) with NR, but a Radio Access Network (RAN) may trigger moving the phone Long Term Evolution (LTE) connected to an Evolved Packet Core (EPC) during call establishment. EPSFB call although initiates on NR but eventually falls back to an LTE layer and succeeds over an EPC core network that is also connected to an Internet Protocol Multimedia Subsystem (IMS), effectively making it Voice over Long-Term Evolution (VOLTE) call after the fallback.

EPSFB call may be coordinated between a 5G System (5GS), and an Evolved Packet System (EPS) systems and transition of the call happens from 5G NR to a legacy LTE network after the negotiation of both UE and network capabilities. At the stage of UE registration, the 5GS and UE capabilities are negotiated during the initial registration process to conclude if EPSFB or Voice over New Radio (VoNR) may be utilized.

To maintain the voice service in Next-Generation Radio Access Network (NG-RAN), the UE provides additional capabilities over a Radio Resource Control (RRC) layer, that may be used to determine accurate NR voice support options. In UE capability information message in NR RRC layer, UE may convey capabilities related to the IMS. After voice over IMS is determined, the UE may start IMS registration and then may make VoNR (or EPSFB) calls.

At the call initiation, if a request for establishing the QoS flow for IMS voice reaches the NG-RAN, NG-RAN may be configured to support EPS fallback for IMS voice and decides to trigger fallback to EPS, taking into account UE capabilities, indication from Access and Mobility Management Function (AMF) that “Redirection for EPS fallback for voice is possible”, network configuration (e.g. N26 availability configuration) and radio conditions, then the redirection or handover procedure to LTE starts. After the UE camps successfully on the LTE cell and initiates Tracking Area Update procedure (TAU) or a fresh attach process (in case of TAU failure or no support for N26), the call continues normally as VOLTE call.

The proposed disclosure enhances user experience by increasing the successful attempts of transition from 5G to 4G for UE which are not capable of VoNR. The proposed disclosure also reduces the delay in transition from 5G to 4G to make a successful voice call. The EPSFB method improves the EPSFB success rate by allowing the user or the UE to take proactive decision to move on to other Radio Access Technology (RAT) when the UE is not capable to make voice call on a 5G Standalone (SA) RAT. The EPSFB method may help the UE to avoid various race condition generated in the system and blocking the UE to select 4G RAT to make voice call. The method may also help the user and the UE to reduce a transition time from 4G to 5G via Inter Radio Access Technology (IRAT) Handover during the EPSFB. The method may trigger the EPSFB via Handover or via Redirection depending upon the situation and Radio Frequency (RF) conditions on a geography where the UE is located. The method may allow the gNB to take quick decision of EPSFB Handover based or redirection based, depending on the RF condition of UE, and Race condition of the system.

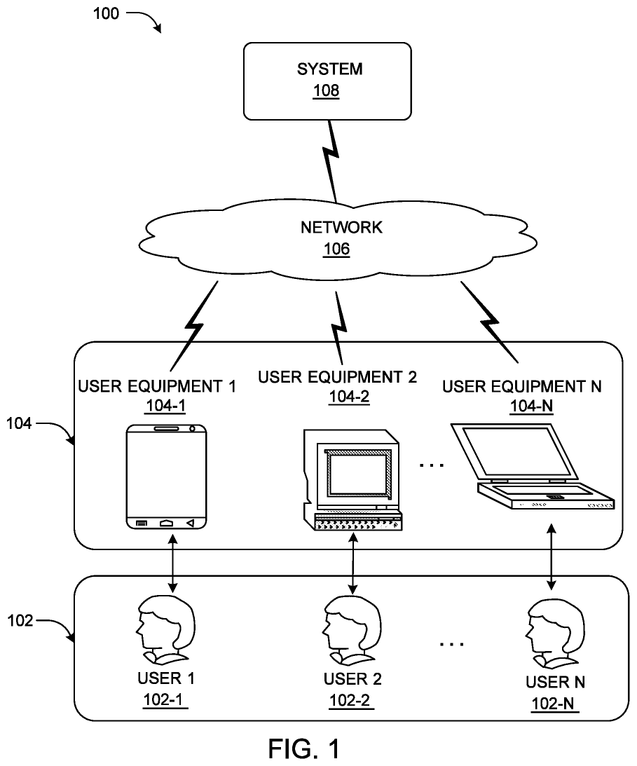

FIG. 1 illustrates an exemplary network architecture (100) in which or with which embodiments of the present disclosure may be implemented.

Referring to FIG. 1, the network architecture (100) may include one or more user equipments (104-1, 104-2 . . . 104-N) associated with one or more users (102-1, 102-2 . . . 102-N) in an environment. A person of ordinary skill in the art will understand that one or more users (102-1, 102-2 . . . 102-N) may be individually referred to as the user (102) and collectively referred to as the users (102). Similarly, a person of ordinary skill in the art will understand that one or more user equipments (104-1, 104-2 . . . 104-N) may be individually referred to as the user equipment (104) and collectively referred to as the user equipment (104). A person of ordinary skill in the art will appreciate that the terms “computing device(s)” and “user equipment” may be used interchangeably throughout the disclosure. Although three user equipments (104) are depicted in FIG. 1, however any number of the user equipments (104) may be included without departing from the scope of the ongoing description.

In an embodiment, the user equipment (104) may include smart devices operating in a smart environment, for example, an Internet of Things (IOT) system. In such an embodiment, the user equipment (104) may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users (102) and/or entities, or any combination thereof. A person of ordinary skill in the art will appreciate that the user equipment (104) may include, but is not limited to, intelligent, multi-sensing, network-connected devices, that can integrate seamlessly with each other and/or with a central server or a cloud-computing system or any other device that is network-connected.

In an embodiment, the user equipment (104) may include, but is not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the user equipment (104) may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the user equipment (104) may include one or more in-built or externally coupled accessories including, but not limited to, a visual aid device such as a camera, an audio aid, a microphone, a keyboard, and input devices for receiving input from the user (102) or the entity such as touch pad, touch enabled screen, electronic pen, and the like. A person of ordinary skill in the art will appreciate that the user equipment (104) may not be restricted to the mentioned devices and various other devices may be used.

Referring to FIG. 1, the user equipment (104) may communicate with a system (108), for example, an Evolved Packet System Fallback (EPSFB) release system, through a network (106). In an embodiment, the network (106) may include at least one of a Fifth Generation (5G) network, or the like. The network (106) may enable the user equipment (104) to communicate with other devices in the network architecture (100) and/or with the system (108). The network (106) may include a wireless card or some other transceiver connection to facilitate this communication. In another embodiment, the network (106) may be implemented as, or include any of a variety of different communication technologies such as a wide area network (WAN), a local area network (LAN), a wireless network, a mobile network, a Virtual Private Network (VPN), the Internet, the Public Switched Telephone Network (PSTN), or the like.

In accordance with embodiments of the present disclosure, the system (108) may be designed and configured for automatically allowing the user to make Voice call on LTE network when the UE is not capable to make Voice call on 5G SA network via redirection or via Handover. Further, the system (108) may allow the user to redirect to LTE RAT on default frequency band configured in gNB during the emergency voice call or when B1 measurement delayed or not received, or while UE is active with other procedure or stuck in race conditions.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

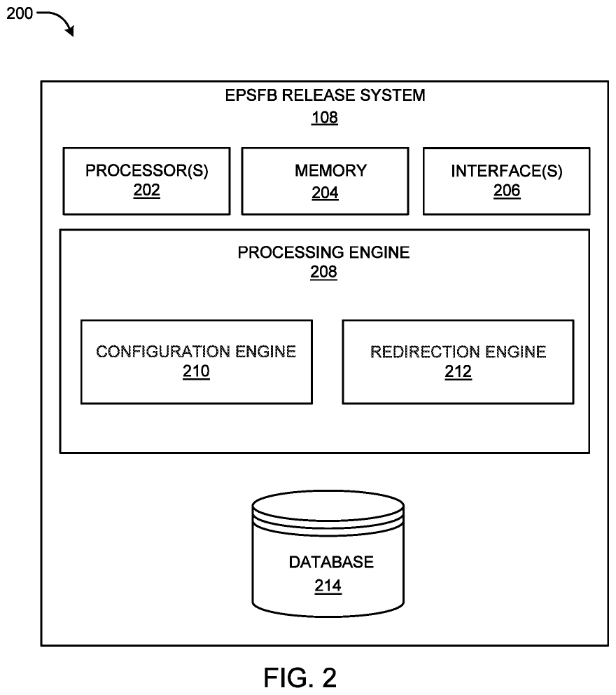

FIG. 2 illustrates an exemplary block diagram of the EPSFB release system (200), in accordance with an embodiment of the present disclosure. It may be appreciated that the system (200) may be similar to the system (108) of FIG. 1 in its functionality.

In an embodiment, and as shown in FIG. 2, the system (200) may include one or more processors (202). The one or more processors (202) may be implemented as one or more microprocessors, microcomputers, microcontrollers, digital signal processors, central processing units, logic circuitries, and/or any devices that manipulate data based on operational instructions. Among other capabilities, the one or more processor(s) (202) may be configured to fetch and execute computer-readable instructions stored in a memory (204) of the system (200). The memory (204) may store one or more computer-readable instructions or routines, which may be fetched and executed to create or share the data units over a network service. The memory (204) may comprise any non-transitory storage device including, for example, volatile memory such as Random-Access Memory (RAM), or non-volatile memory such as Erasable Programmable Read-Only Memory (EPROM), flash memory, and the like.

In an embodiment, the system (200) may also comprise an interface(s) (206). The interface(s) (206) may comprise a variety of interfaces, for example, a variety of interfaces, for example, interfaces for data input and output devices, referred to as I/O devices, storage devices, and the like. The interface(s) (206) may facilitate communication of the system (200) with various devices coupled to it. The interface(s) (206) may also provide a communication pathway for one or more components of the system (200). Examples of such components include, but are not limited to, processing engine(s) (208) and a database (214).

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the one or more processors (202) may comprise a processing resource (for example, one or more processors), to execute such instructions. In the present examples, the machine-readable storage medium may store instructions that, when executed by the processing resource, implement the processing engine(s) (208). In such examples, the system (200) may comprise the machine-readable storage medium storing the instructions and the processing resource to execute the instructions, or the machine-readable storage medium may be separate but accessible to the system (200) and the processing resource. In other examples, the processing engine(s) (208) may be implemented by electronic circuitry.

In an embodiment, the database (214) may comprise data that may be either stored or generated as a result of functionalities implemented by any of the components of the processor(s) (202) or the processing engine(s) (208) or the system (200). In an exemplary embodiment, the processing engine(s) (208) may include a configuration engine (210), and a redirection engine (212).

In an embodiment, the configuration engine (210) may receive a Packet Data Unit (PDU) session modification request from an Access and Mobility Management Function (AMF) for voice call. After receiving the PDU modification request, a gNodeB (gNB) may abort other activities if it is active with other intra 5G system handover procedure, like waiting for A3 or A5 event Measurement Report (MR) from UE or if MR received and preparing for Intra 5G system handover and performs emergency release with redirection on predefined configured LTE Band. If the gNB is not active with other internal procedure while receiving PDU modification request for 5G Quality of Service (QOS) identifier (5QI), the configuration engine (210) may configure the UE for B1 measurement report and start process Timer.

In an embodiment, the redirection engine (212) may redirect the UE to release with redirection on predefined configured LTE band, if any A3 MR is received from the UE configured in previous Radio Resource Control (RRC) reconfiguration, even after configuration of B1. The A3 event occurs when a neighbouring cell's signal becomes offset better than the serving cell. It is used in both intra-frequency and inter-frequency handovers. The A5 event occurs when a serving cell becomes worse than threshold-1 and neighbor becomes better than threshold-2.

Although FIG. 2 shows an exemplary block diagram (200) of the EPSFB release system, in other embodiments, the EPSFB release system (200) may include fewer components, different components, differently arranged components, or additional functional components than depicted in FIG. 1. Additionally, or alternatively, one or more components of the EPSFB release system (200) may perform functions described as being performed by one or more other components of the EPSFB release system (200).

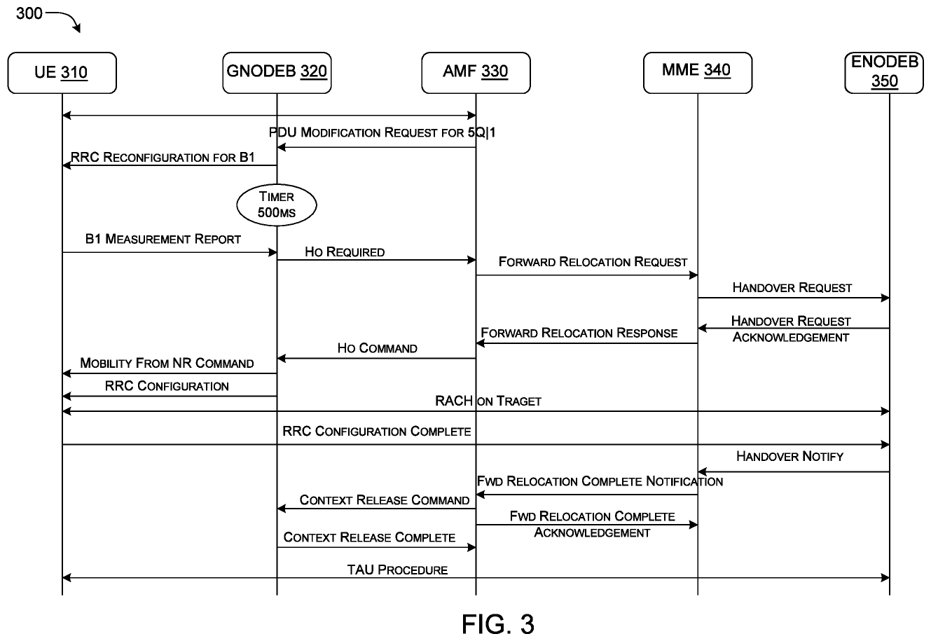

FIG. 3 illustrates an exemplary flow mechanism (300) of 5G to 4G Inter-Radio Access Technology (RAT) handover, in accordance with an embodiment of the present disclosure.

With respect to FIG. 3, N26 interface between Access and Mobility Management Function (AMF) (330) and Mobility Management Entity (MME) (340) may use forward relocation procedure, and session management context and user plane tunnels in core network are exchanged over from Session Management Function/Unified Performance Management (SMF/UPM) to MME/Serving Gateway (S-GW).

The AMF (330) sends a packet data unit (PDU) modification request for 5QI 1 to gNodeB (320). The gNodeB (320) sends a radio resource control (RRC) reconfiguration for B1 measurement and starts a timer (e.g., 500 ms). The UE (310) sends the B1 measurement report to the gNodeB (320). The gNodeB (320) sends a handover required request to the AMF (330) that further sends a forward relocation request to an MME (340). The MME (340) sends a handover request to the eNodeB (350) of a second network (4G LTE network). The eNodeB (350) acknowledges the handover request and the MME (340) forwards a forward relocation request to the AMF (330) that further sends a handover command to the gNodeB (320). The gNodeB (320) sends a mobility from NR command and a RRC configuration to the UE (310). The mobility from NR command is a critical component in facilitating smooth handovers and transitions from a universal mobile telecommunications system (UMTS) terrestrial radio access network (UTRAN) to 5G new radio (NR). The command provides the necessary instructions and parameters for the UE (310) to execute a seamless handover, ensuring continuous and reliable communication within the 5G network. The UE (310) configures a random-access channel (RACH) on target with the eNodeB (350) and completes the RRC configuration. The eNodeB (350) notifies the MME (340) regarding the handover and the MME (340) forwards a relocation complete notification to the AMF (330). The AMF (330) sends a context release command to the gNodeB (320). The AMF (330) forwards a relocation complete acknowledgement to the MME (340). The gNodeB (320) sends a context release complete notification to the AMF (330). The UE (310) initiates a tracking area update (TAU) procedure by sending a TAU request message to the eNodeB (350). The message includes information about the UE's current location, such as the new tracking area (TA) it has entered.

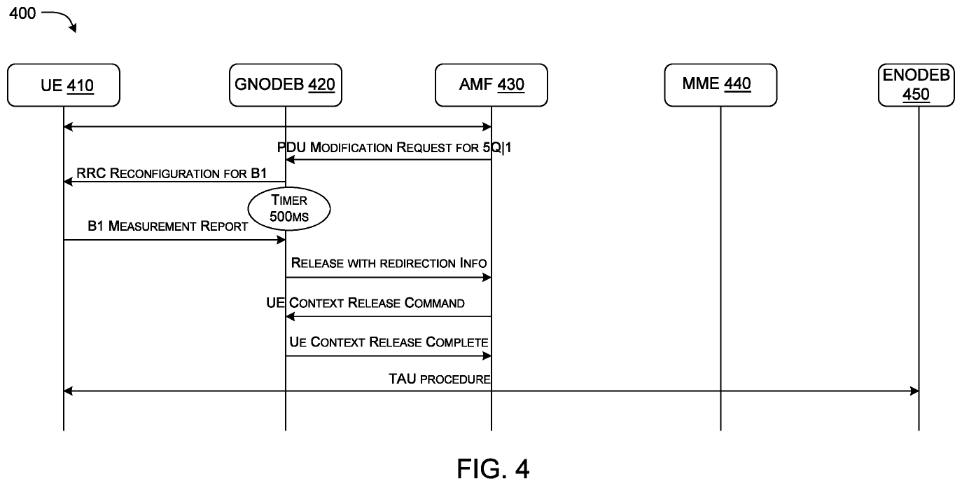

FIG. 4 illustrates an exemplary flow mechanism (400) for performing 5G to 4G release with redirection, in accordance with an embodiment of the present disclosure. With respect to FIG. 4, 5G radio connection may be released with a 5G RRC Release instructing UE (410) to reselect to a 4G cell where a new radio connection may be started for the VOLTE call. In this case the UE context may be transferred from the AMF (430) to the MME (440) over the N26interface. The choice of method used for EPSFB may depend on UE capability and 5G Core Network Capability

The EPSFB release system (108) may automatically allow the user to make Voice call on LTE network when UE (410) is not capable to make Voice call on 5G SA network via redirection or via Handover. The EPSFB release system (108) may first prioritize the transition from 5G to 4G during EPSFB via handover, if there is unprecedented failure during the handover procedure it will allow user to release the 5G SA network and redirect to measured Evolved Universal Terrestrial Radio Access (E-UTRA) Absolute Radio Frequency Channel Number (EARFCN) of LTE band to proceed the EPSFB call successfully.

The EPSFB release system (108) may allow the user to redirect to LTE RAT on default frequency band configured in gNB during the emergency voice call or when B1 measurement delayed or not received, or while UE (410) is active with other procedure or stuck in race conditions.

The AMF (430) sends a packet data unit (PDU) modification request for 5QI 1 to gNodeB (420). The gNodeB (420) sends a radio resource control (RRC) reconfiguration for B1 measurement to the UE (410) and starts a timer (e.g., 500 ms). The UE (410) sends the B1 measurement report to the gNodeB (420). The gNodeB (420) sends a release with direction info command to the AMF (430) that further sends a UE context release command to the gNodeB (420). The gNodeB (420) sends a UE context release complete command to the AMF (430). The UE (410) initiates a tracking area update (TAU) procedure by sending a TAU request message to the eNodeB (450). The message includes information about the UE's current location, such as the new tracking area (TA) it has entered.

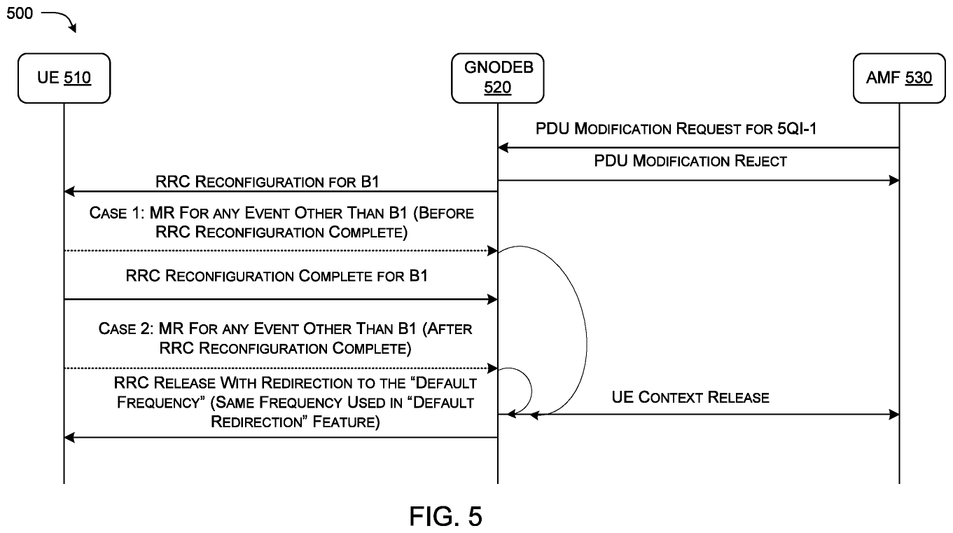

FIG. 5 illustrates an exemplary flow mechanism (500) of EPSFB by emergency redirection, in accordance with an embodiment of the present disclosure. With respect to FIG. 5, after receiving the PDU session modification request from AMF (530) for 5Q1 1 (5G QoS Identifier) QOS flow of IMS voice. The PDU modification request may get rejected by the gNodeB (520). The gNB (520) may configure the UE (510) for B1 measurements (RRC reconfiguration) and set a wait timer to receive the B1 measurement report. There are chances of two cases to arise:

Case 1: When measurement report (MR) for any event other than B1 is received from the UE before the RRC reconfiguration gets completes (before the wait timer expiry), then RRC release with redirection is performed by the gNodeB (520) to the “default frequency”. The default frequency is the same frequency that is used in “Default redirection” feature. The UE (510) may fail to send the B1 measurement before the wait timer expiry due to some uncertainty. The gNodeB (520) starts release with redirection process to default frequency configured in the gNodeB (520). This issue may be also observed when the EPSFB procedure via release with redirection to reported frequency is enabled.

Case 2: When measurement report (MR) for any event other than B1 is received from the UE (510) after the RRC reconfiguration gets completes (after the wait timer expiry), then RRC release with redirection is performed by the gNodeB (520) to the “default frequency”.

In an embodiment, in both the scenario of case 1 and case 2 the UE context release is transferred from the gNodeB (520) to the AMF (530).

Further, if the measurement report (MR) is received for any event other than B1 before or after the completion of the RRC reconfiguration, then whether the MR has E-UTRAN Cell Global Identifier (ECGI) or not is not to be checked by the gNodeB (520) and “Emergency Redirection” should be triggered.

The E-UTRAN Cell Global Identifier (ECGI) is a critical element in LTE (Long-Term Evolution) networks that uniquely identifies each cell in the E-UTRAN. It provides valuable information about the cell's identity, enabling various functionalities and optimization within the network.

In an embodiment, the gNodeB (520) may wait for the B1 measurement report from the UE (510) to take decision of release with redirection, when timer expires, the gNB (520) starts release with redirection process to default frequency configured in the gNB (520).

Further, in the prior art, the EPSFB may not be triggered by an Outdoor Small Cell (ODSC) when it receives an A3 event Measurement Report (MR) for Intra-FA handover to the neighbour cell while it is waiting for B1 MR to start EPSFB. This may be solved by the present invention emergency redirection process because the action to trigger EPSFB may be taken instantly when the MR for any event other than B1 is received while the UE has initiated a voice call.

Further, in the prior art, the EPSFB may not be triggered when the UE (510) already sent the A3 event measurement and the gNB (520) is preparing for Intra-FA handover. This may be solved by the present invention emergency redirection process because the action to trigger the EPSFB may be taken instantly while the UE (510) has initiated the voice call.

Thus, when a normal process (prior art technique) of waiting for B1 MR is followed, then the UE is likely to face ‘Radio Link Failure’ (RLF) due to poor RF in the handover zone. The RLF occurs when the radio link between the user equipment (UE) and the eNodeB (base station) is lost. This can happen due to various reasons such as interference, coverage issues, handover failures, or equipment malfunction.

Thus, the present invention solves the drawbacks present in the prior art and provides a technique that can automatically allow the user to make voice call on LTE network when UE is not capable to make voice call on 5G standalone (SA) network via redirection or via handover. The present invention, prioritize the transition from 5G to 4G during EPS fall back (FB) via handover, if there is unprecedented failure during the handover procedure it will allow user to release the 5G SA network and redirect to measured evolved universal terrestrial radio access (E-UTRA) absolute radio frequency channel number (EARFCN) of the LTE band to proceed the EPSFB call successfully.

Thus, the present invention allows user to blindly redirect to LTE RAT on default frequency band configured in gNodeB during the emergency voice call or when B1 measurement delayed or not received, or while UE is active with other procedure or stuck in race conditions.

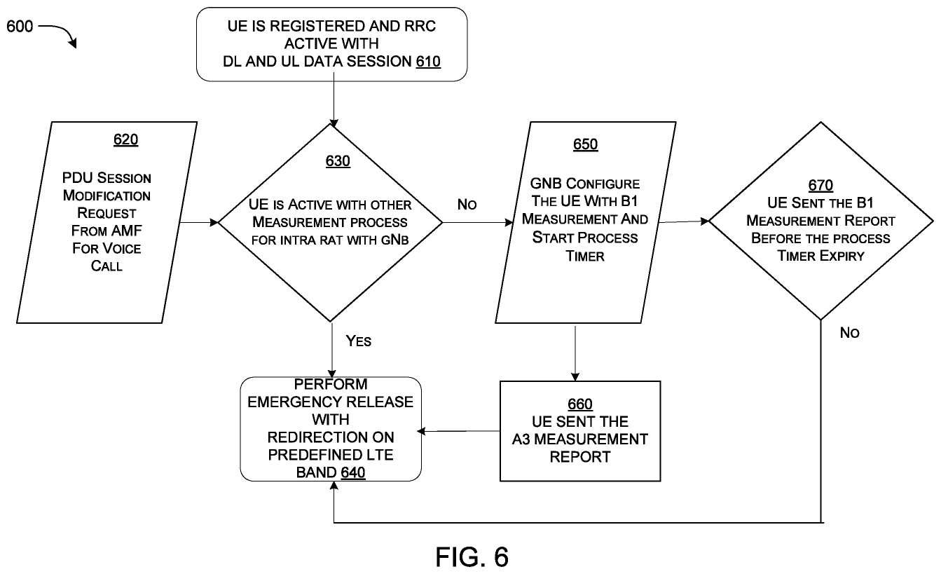

FIG. 6 illustrates an exemplary flow diagram (600) for performing emergency release with redirection on predefined Long-Term Evolution (LTE) band, in accordance with an embodiment of the present disclosure. With respect to FIG. 6, at 610, UE may be already registered with Radio Resource Control (RRC) active with Downlink (DL) and Uplink (UL) Data Session.

At 620, Packet Data Unit (PDU) session modification request may be received from an Access and Mobility Management Function (AMF) for voice call.

At 630, after receiving the PDU modification request, the gNB may abort other activities if it is active with other intra 5G system handover procedure, like waiting for A3 or A5 MR from UE or if MR is Received and preparing for intra 5G system handover.

At 640, the gNB may perform emergency release with redirection on predefined configured LTE Band.

At 650, if the gNB is not active with other internal procedure while PDU modification request for 5Q1 1 is received, the gNB may configure the UE for B1 measurement report and start process timer.

At 660, even after configuration of B1, if any A3 MR is received from the UE configured in previous RRC reconfiguration, the gNB may redirect the UE to release with redirection on predefined configured LTE band.

At 670, when the UE missed to send the B1 measurement report within a process timer window, the gNB may redirect the UE to release with redirection on predefined configured LTE band.

In an embodiment, the emergency redirection may be performed by the gNB after checking mandatory condition, when the PDU modification request for 5QI 1 is received from the AMF:
a. When the UE and the GNB are already active with another inter-RAT handover procedure.
b. After configuring the UE for B1 measurement if UE the does not send the measurement report within the predefined time configured by process timer, B1 report Timer.
c. After configuring the UE for B1 measurement if the UE reports measurement for any event other than B1 (A3 or A5).

These mandatory conditions may check, enable the UE to explore all network connection options, prior to emergency handover, and optimize the resource usage for emergency handover procedures of the UEs in the network.

In an exemplary embodiment, the present invention discloses a method for an evolved packet system fallback (EPSFB). The method comprising receiving, by a gNodeB, at least one packet data unit (PDU) session modification request related to a voice call for a user equipment (UE) connected to a first network. The method comprising determining if the gNodeB is active with the UE on at least one activity after receiving the PDU session modification request. When it is determined that the gNodeB is active with the UE on the at least one activity: aborting, by the gNodeB, the at least one activity; performing, by the gNodeB, a release of the UE from the connection with the first network and redirect the UE on a predefined configured frequency band of a second network. When it is determined that the gNodeB is not active with the at least one activity: configuring the UE with a first event measurement, starting a timer having a start time and an end time and performing, by the gNodeB, a release of the UE from the connection with the first network and redirect the UE on the predefined configured frequency band of the second network. The method comprising performing, by the gNodeB, a release of the UE from the connection with the first network and redirect the UE on the predefined configured frequency band of the second network when at least one of the following conditions are met a first measurement report (MR) associated with the one first event measurement is not received between the start time and the end time of the timer, and at least one second MR related to at least one second event measurement is received from the UE after the UE is configured with the first event measurement.

In some embodiments, the at least one UE is registered with at least one radio resource control (RRC) active mode with a downlink (DL) data session and an uplink (UL) data session.

In some embodiments, the at least one activity includes at least one inter-radio access technology (RAT) handover procedure.

In some embodiments, the first MR related to the first event measurement received from the UE is a B1 measurement report.

In some embodiments, the at least one second event measurement includes a measurement related to a A3 event and a A5 event.

In some embodiments, the PDU session modification request is received from an access & mobility management function (AMF) associated with the first network.

In some embodiments, the predefined configured frequency band of the second network is associated with an evolved universal terrestrial radio access (E-UTRA) absolute radio frequency channel number (EARFCN).

In some embodiments, the first network is a 5G network and the second network is a 4G long-term evolution (LTE) network.

In some embodiments, the EPSFB is triggered through a handover procedure or a redirection procedure depending upon a plurality of radio frequency (RF) conditions of the UE.

In some embodiments, the plurality of radio frequency (RF) conditions of the UE depends on a geographical area where the UE is located.

In some embodiments, the EPSFB is triggered through a handover procedure or a redirection procedure depending upon the at least one race condition generated in the first network.

In some embodiments, the gNodeB performs an emergency release of the UE from the connection with the first network and performs an emergency redirection of the UE on the predefined configured frequency band of the second network.

In some embodiments, the gNodeB performs the emergency redirection of the UE on the predefined configured frequency band of the second network instantly.

In some embodiments, the predefined configured frequency band is determined based on at least one of UE capability information message received from the UE, a message from the AMF that comprises an indication regarding a possibility of redirection for the EPSFB, N26 interface availability configuration and the plurality of RF conditions of the UE.

In an exemplary embodiment, the present invention discloses a system for an evolved packet system fallback (EPSFB). The system is configured to receive, by a gNodeB, at least one packet data unit (PDU) session modification request related to a voice call for a user equipment (UE) connected to a first network. The system is configured to determine if the gNodeB is active with the UE on at least one activity after receiving the PDU session modification request. When it is determined that the gNodeB is active with the UE on at least one activity: abort, by the gNodeB, the at least one activity; perform, by the gNodeB, a release of the UE from the connection with the first network and redirect the UE on a predefined configured frequency band of a second network. When it is determined that the gNodeB is not active with the at least one activity: configure the UE with a first event measurement; start a timer having a start time and an end time, perform, by the gNodeB, a release of the UE from the connection with the first network and redirect the UE on the predefined configured frequency band of the second network. The system is configured to perform, by the gNodeB, a release of the UE from the connection with the first network and redirect the UE on the predefined configured frequency band of the second network when at least one of the following conditions are met a first measurement report (MR) associated with the one first event measurement is not received between the start time and the end time of the timer, and at least one second MR related to at least one second event measurement is received from the UE after the UE is configured with the first event measurement.

In an exemplary embodiment, the present invention discloses a network comprising at least one network element for performing an evolved packet system fallback (EPSFB). The at least one network element is configured to receive, by a gNodeB, at least one packet data unit (PDU) session modification request related to a voice call for a user equipment (UE) connected to the network. The at least one network element is configured to determine if the gNodeB is active with the UE on at least one activity after receiving the PDU session modification request. The at least one network element is configured to responsive to determining that the gNodeB is active with the at least one activity: abort, by the gNodeB, the at least one activity, perform, by the gNodeB, a release of the UE from the connection with the network and redirect the UE on a predefined configured frequency band of another network. The at least one network element is configured to responsive to determining that the gNodeB is not active with the at least one activity: configure the UE with a first event measurement and start a timer having a start time and an end time. The at least one network element is configured to perform, by the gNodeB, a release of the UE from the connection with the network and redirect the

UE on the predefined configured frequency band of the another network when at least one of the following conditions are met a first measurement report (MR) associated with the first event measurement is not received between the start time and the end time of the timer and at least one second MR related to at least one second event measurement from the UE after the UE is configured with the first event measurement.

In an exemplary embodiment, the present invention discloses a user equipment (UE) attached to a network. The network comprising at least one network element for performing an evolved packet system fallback (EPSFB). The at least one network element is configured to receive, by a gNodeB, at least one packet data unit (PDU) session modification request related to a voice call for the UE. The at least one network element is configured to determine if the gNodeB is active with the UE on at least one activity after receiving the PDU session modification request. The at least one network element is configured to responsive to determining that the gNodeB is active with the at least one activity: abort, by the gNodeB, the at least one activity, perform, by the gNodeB, a release of the UE from the connection with the network and redirect the UE on a predefined configured frequency band of another network. The at least one network element is configured to responsive to determining that the gNodeB is not active with the at least one activity: configure the UE with a first event measurement and start a timer having a start time and an end time. The at least one network element is configured to perform, by the gNodeB, a release of the UE from the connection with the network and redirect the UE on the predefined configured frequency band of the another network when at least one of the following conditions are met a first measurement report (MR) associated with the first event measurement is not received between the start time and the end time of the timer and at least one second MR related to at least one second event measurement from the UE after the UE is configured with the first event measurement.

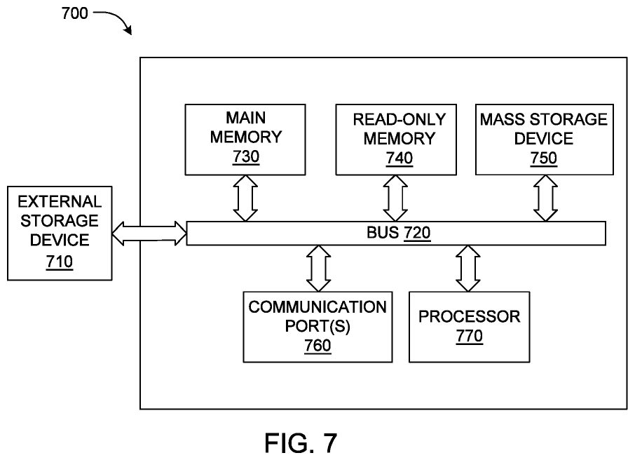

FIG. 7 illustrates an exemplary computer system (700) in which or with which embodiments of the present disclosure may be implemented. In an implementation, the EPSFB release system 108 may be implanted by the computer system (700). As shown in FIG. 7, the computer system (700) may include an external storage device (710), a bus (720), a main memory (730), a read only memory (740), a mass storage device (750), a communication port (760), and a processor (770). A person skilled in the art will appreciate that the computer system (700) may include more than one processor (770) and communication ports (760).

Processor (770) may include various modules associated with embodiments of the present disclosure.

In an embodiment, the communication port (760) may be any of an RS-232 port for use with a modem-based dialup connection, a 10/100 Ethernet port, a Gigabit or 10 Gigabit port using copper or fiber, a serial port, a parallel port, or other existing or future ports. The communication port (760) may be chosen depending on a network, such a Local Area Network (LAN), Wide Area Network (WAN), or any network to which computer system connects.

In an embodiment, the memory (730) may be Random Access memory (RAM), or any other dynamic storage device commonly known in the art. Read-only memory (740) may be any static storage device(s) e.g., but not limited to, a Programmable Read Only Memory (PROM) chips for storing static information e.g., start-up or Basic Input/Output System (BIOS) instructions for the processor (770).

In an embodiment, the mass storage (750) may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus (720) communicatively couples the processor(s) (770) with the other memory, storage and communication blocks. The bus (720) may be, e.g., a Peripheral Component Interconnect (PCI)/PCI Extended (PCI-X) bus, Small Computer System Interface (SCSI), Universal Serial Bus (USB) or the like, for connecting expansion cards, drives and other subsystems as well as other buses, such a front side bus (FSB), which connects the processor (770) to the computer system (700).

Optionally, operator and administrative interfaces, e.g., a display, keyboard, joystick, and a cursor control device, may also be coupled to the bus (720) to support direct operator interaction with the computer system (700). Other operator and administrative interfaces may be provided through network connections connected through the communication port (760). Components described above are meant only to exemplify various possibilities. In no way should the aforementioned exemplary computer system (700) limit the scope of the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

In an aspect, the present disclosure provides a system, and a method that allows a user equipment (UE) to get redirected on default Long-Term Evolution (LTE) frequency band when the UE stuck in any race condition with other handover procedure and improves the user experience. In an aspect, the present disclosure. The present disclosure improves network Key Performance Indicators (KPI) of EPSFB success rate.

In an aspect, the present disclosure can be implemented within a communication network with multi-RAT, multi-vendor consisting of different product like macro, micro and small cell.

### ADVANTAGES OF THE PRESENT DISCLOSURE

The present disclosure may reduce the delay in Evolved Packet System Fallback (EPSFB) procedure when a gNodeB (gNB) is automatically taking decision to start EPSFB with release with redirection.

The present disclosure may allow User Equipment (UE) to get redirected on default Long-Term Evolution (LTE) frequency band when the UE stuck in any race condition with other handover procedure and improves the user experience.

The present disclosure may allow the UE to release with redirection to default LTE frequency with emergency fallback, when the UE is active with some other handover procedure.

The present disclosure may be well suited for any heterogeneous network with Multi-Radio Access Technology (RAT), multi-vendor consisting of different product like Macro, Micro and small cell.

The present disclosure may improve network Key Performance Indicators (KPI) of EPSFB success rate.

We claim:

1. A method for an evolved packet system fallback (EPSFB), the method comprising:
receiving, by a gNodeB (320, 420, 520), at least one packet data unit (PDU) session modification request related to a voice call for a user equipment (UE) (104, 310, 410, 510) connected to a first network;
determining if the gNodeB (320, 420, 520) is active with the UE (104, 310, 410, 510) on at least one activity after receiving the PDU session modification request;
responsive to determining that the gNodeB (320, 420, 520) is active with the UE (104, 310, 410, 510) on the at least one activity;
aborting, by the gNodeB (320, 420, 520), the at least one activity;
performing, by the gNodeB (320, 420, 520), a release of the UE (104, 310, 410, 510) from the connection with the first network and redirect the UE (104, 310, 410, 510) on a predefined configured frequency band of a second network;
responsive to determining that the gNodeB (320, 420, 520) is not active with the at least one activity:
configuring the UE (104, 310, 410, 510) with a first event measurement and starting a timer having a start time and an end time; and
performing, by the gNodeB (320, 420, 520), a release of the UE (104, 310, 410, 510) from the connection with the first network and redirect the UE (104, 310, 410, 510) on the predefined configured frequency band of the second network when at least one of the following conditions are met:
a first measurement report (MR) associated with the first event measurement is not received between the start time and the end time of the timer; and
at least one second MR related to at least one second event measurement is received from the UE (104, 310, 410, 510) after the UE (104, 310, 410, 510) is configured with the first event measurement.

2. The method as claimed in claim 1, wherein the at least one UE (104, 410, 510) is registered with at least one radio resource control (RRC) active mode with a downlink (DL) data session and an uplink (UL) data session.

3. The method as claimed in claim 1, wherein the at least one activity includes at least one inter-radio access technology (RAT) handover procedure.

4. The method as claimed in claim 1, wherein the first MR related to the first event measurement received from the UE (104, 310, 410, 510) is a B1 measurement report.

5. The method as claimed in claim 1, wherein the at least one second event measurement includes a measurement related to a A3 event and a A5 event.

6. The method as claimed in claim 1, wherein the PDU session modification request is received from an access & mobility management function (AMF) (330, 430, 530) associated with the first network.

7. The method as claimed in claim 1, wherein the predefined configured frequency band of the second network is associated with an evolved universal terrestrial radio access (E-UTRA) absolute radio frequency channel number (EARFCN).

8. The method as claimed in claim 1, wherein the first network is a 5G network and the second network is a 4G long-term evolution (LTE) network.

9. The method as claimed in claim 1, wherein the EPSFB is triggered through a handover procedure or a redirection procedure depending upon a plurality of radio frequency (RF) conditions of the UE (104, 310, 410, 510).

10. The method as claimed in claim 1, wherein the plurality of radio frequency (RF) conditions of the UE (104, 310, 410, 510) depends on a geographical area where the UE (104, 310, 410, 510) is located.

11. The method as claimed in claim 1, wherein the EPSFB is triggered through a handover procedure or a redirection procedure depending upon the at least one race condition generated in the first network.

12. The method as claimed in claim 1, wherein the gNodeB (320, 420, 520) performs an emergency release of the UE (104, 310, 410, 510) from the connection with the first network and performs an emergency redirection of the UE (104, 310, 410, 510) on the predefined configured frequency band of the second network.

13. The method as claimed in claim 1, wherein the gNodeB (320, 420, 520) performs the emergency redirection of the UE (104, 310, 410, 510) on the predefined configured frequency band of the second network instantly.

14. The method as claimed in claim 1, wherein the predefined configured frequency band is determined based on at least one of:
UE capability information message received from the UE (104, 310, 410, 510);
a message from the AMF (330, 430, 530) that comprises an indication regarding a possibility of redirection for the EPSFB;
N26 interface availability configuration; and
the plurality of RF conditions of the UE (104, 310, 410, 510).

15. A system for an evolved packet system fallback (EPSFB), the system is configured to:
receive, by a gNodeB (320, 420, 520), at least one packet data unit (PDU) session modification request related to a voice call for a user equipment (UE) (104, 310, 410, 510) connected to a first network;
determine if the gNodeB (320, 420, 520) is active with the UE (104, 310, 410, 510) on at least one activity after receiving the PDU session modification request;
when it is determined that the gNodeB (320, 420, 520) is active with the at least one activity:
abort, by the gNodeB (320, 420, 520), the at least one activity;
perform, by the gNodeB (320, 420, 520), a release of the UE (104, 310, 410, 510) from the connection with the first network and redirect the UE (104, 310, 410, 510) on a predefined configured frequency band of a second network;
responsive to determining that the gNodeB (320, 420, 520) is not active with the at least one activity:
configure the UE (104, 310, 410, 510) with a first event measurement;
start a timer having a start time and an end time;
perform, by the gNodeB (320, 420, 520) a release of the UE (104, 310, 410, 510) from the connection with the first network and redirect the UE (104, 310, 410, 510) on the predefined configured frequency band of the second network when at least one of the following conditions are met:
a first measurement report (MR) associated with the first event measurement is not received between the start time and the end time of the timer;
and
at least one second MR related to at least one second event measurement is received from the UE (104, 310, 410, 510) after the UE (104, 310, 410, 510) is configured with the first event measurement.

16. The system as claimed in claim 15, wherein the at least one UE (104, 310, 410, 510) is registered with at least one radio resource control (RRC) active mode with a downlink (DL) data session and an uplink (UL) data session.

17. The system as claimed in claim 15, wherein the at least one activity includes at least one inter-radio access technology (RAT) handover procedure.

18. The system as claimed in claim 15, wherein the first MR related to the first event measurement received from the UE (104, 310, 410, 510) is a B1 measurement report.

19. The system as claimed in claim 15, wherein the at least one second event measurement includes a measurement related to a A3 event and a A5 event.

20. The system as claimed in claim 15, wherein the PDU session modification request is received from an access & mobility management function (AMF) (330, 430, 530) associated with the first network.

21. The system as claimed in claim 15, wherein the predefined configured frequency band of the second network is associated with an evolved universal terrestrial radio access (E-UTRA) absolute radio frequency channel number (EARFCN).

22. The system as claimed in claim 15, wherein the first network is a 5G network and the second network is a 4G long-term evolution (LTE) network.

23. The system as claimed in claim 15, wherein the EPSFB is triggered through a handover procedure or a redirection procedure depending upon a plurality of radio frequency (RF) conditions of the UE (104, 310, 410, 510).

24. The system as claimed in claim 15, wherein the plurality of radio frequency (RF) conditions of the UE (104, 310, 410, 510) depends on a geographical area where the UE (104, 310, 410, 510) is located.

25. The system as claimed in claim 15, wherein the EPSFB is triggered through a handover procedure or a redirection procedure depending upon the at least one race condition generated in the first network.

26. The system as claimed in claim 15, wherein the gNodeB (320, 420, 520) performs an emergency release of the UE (104, 310, 410, 510) from the connection with the first network and performs an emergency redirection of the UE (104, 310, 410, 510) on the predefined configured frequency band of the second network.

27. The system as claimed in claim 15, wherein the gNodeB (320, 420, 520) performs the emergency redirection of the UE (104, 310, 410, 510) on the predefined configured frequency band of the second network instantly.

28. The system as claimed in claim 15, wherein the predefined configured frequency band is determined based on at least one of:
UE capability information message received from the UE (104, 310, 410, 510);
a message from the AMF (330, 430, 530) that comprises an indication regarding a possibility of redirection for the EPSFB;
N26 interface availability configuration; and
the plurality of RF conditions of the UE (104, 310, 410, 510).

29. A network comprising at least one network element for performing an evolved packet system fallback (EPSFB), the at least one network element is configured to:
receive, by a gNodeB (320, 420, 520), at least one packet data unit (PDU) session modification request related to a voice call for a user equipment (UE) (104, 310, 410, 510) connected to the network;
determine if the gNodeB (320, 420, 520) is active with the UE (104, 310, 410, 510) on at least one activity after receiving the PDU session modification request;
responsive to determining that the gNodeB (320, 420, 520) is active with the at least one activity:
abort, by the gNodeB (320, 420, 520), the at least one activity;
perform, by the gNodeB (320, 420, 520), a release of the UE (104, 310, 410, 510) from the connection with the network and redirect the UE (104, 310, 410, 510) on a predefined configured frequency band of another network;
responsive to determining that the gNodeB (320, 420, 520) is not active with the at least one activity:
configure the UE (104, 310, 410, 510) with a first event measurement and start a timer having a start time and an end time;
perform, by the gNodeB (320, 420, 520), a release of the UE (104, 310, 410, 510) from the connection with the network and redirect the UE (104, 310, 410, 510) on the predefined configured frequency band of the another network when at least one of the following conditions are met:
a first measurement report (MR) associated with the first event measurement is not received between the start time and the end time of the timer; and
at least one second MR related to at least one second event measurement from the UE (104, 310, 410, 510) after the UE (104, 310, 410, 510) is configured with the first event measurement.

30. A user equipment (UE) (104, 310, 410, 510) attached to a network, wherein the network comprising at least one network element for performing an evolved packet system fallback (EPSFB), the at least one network element is configured to:
receive, by a gNodeB (320, 420, 520), at least one packet data unit (PDU) session modification request related to a voice call for the UE (104, 310, 410, 510);
determine if the gNodeB (320, 420, 520) is active with the UE (104, 310, 410, 510) on at least one activity after receiving the PDU session modification request;
responsive to determining that the gNodeB (320, 420, 520) is active with the at least one activity:
abort, by the gNodeB (320, 420, 520), the at least one activity;
perform, by the gNodeB (320, 420, 520), a release of the UE (104, 310, 410, 510) from the connection with the network and redirect the UE (104, 310, 410, 510) on a predefined configured frequency band of another network;
responsive to determining that the gNodeB (320, 420, 520) is not active with the at least one activity:
configure the UE (104, 310, 410, 510) with a first event measurement and start a timer having a start time and an end time;
perform, by the gNodeB (320, 420, 520), a release of the UE (104, 310, 410, 510) from the connection with the network and redirect the UE (104, 310, 410, 510) on the predefined configured frequency band of the another network when at least one of the following conditions are met:
a first measurement report (MR) associated with the first event measurement is not received between the start time and the end time of the timer; and
at least one second MR related to at least one second event measurement from the UE (104, 310, 410, 510) after the UE (104, 310, 410, 510) is configured with the first event measurement.
